(19) United States
(12) Patent Application Publication
(10) Pub. No.: US 2024/0343162 A1
(43) Pub. Date: Oct. 17, 2024

(54) DEVICE AND METHOD FOR HEATING A TRACTION BATTERY

(71) Applicant: Robert Bosch GmbH, Stuttgart (DE)

(72) Inventors: Georg Hoegele, Hemmingen (DE); Julian Gollenstede, Pforzheim (DE)

(21) Appl. No.: 18/683,203

(22) PCT Filed: Jul. 25, 2022
(86) PCT No.: PCT/EP2022/070762

§ 371 Date: Feb. 12, 2024

(30) Foreign Application Priority Data
Sep. 9, 2021 (DE) 10 2021 209 949.1

(51) Int. Cl. B60L 58/27; B60L 7/22; B60L 50/60; H01M 10/613; H01M 10/625; H01M 10/656

(52) U.S. Cl. CPC B60L 58/27; B60L 7/22; B60L 50/60; H01M 10/613; H01M 10/625; H01M 10/656; H01M 2220/20

(57) ABSTRACT

The invention relates to a device (100) and to a method (400) for heating a traction battery (50) in a vehicle (300). The device (100) comprises an electric consumer (10), which consumes a load current during operation and generates waste heat, the electric consumer (10) being operated to heat the traction battery (50). The device (100) comprises a drive connection (80) for connecting an electric drive (90). The electric consumer (10) comprises a braking resistor for consuming regenerative electric power from the electric drive (90).

### BACKGROUND

The invention relates to a device for heating a traction battery and a method for heating a traction battery. The invention furthermore relates to a powertrain with a corresponding device and a vehicle with a powertrain, as well as a computer program and a computer-readable medium.

Batteries have temperature dependencies. Thus, ambient temperatures below room temperature reduce battery capacity. This effect is caused, for example, by the temperature-dependent conductivity of the electrolyte and the internal resistance of a battery. In order to be able to operate battery cells efficiently even at low ambient temperatures, these batteries are heated to an optimum operating temperature as quickly as possible. DE 10 2012 210 146 A1 discloses a device for heating a battery with a heating element that is integrated into the battery. The heating element is supplied with electrical power as needed and consequently emits waste heat, which is used for heating the battery.

Consequently, an additional component, the heating element, is required for heating the battery.

There is therefore a need for devices and methods for heating batteries without additional components.

Brake resistors in electric powertrains serve to convert the generated electrical power or energy of the traction motors that are switched as generators of electric or diesel-electric vehicles, traction vehicles, or trolley buses into waste heat in the event of a fault when it is no longer possible to redirect the energy into a battery or connected power supply system. To remove the waste heat, the braking resistors used for this purpose are mounted outside the powertrain, and preferably on the roof or in or under a vehicle in mobile applications. Vehicles must be equipped with redundant braking devices. Braking resistors are used for this purpose.

### SUMMARY

A device for heating a traction battery in a vehicle is provided, the device comprising an electric consumer, wherein the electric consumer consumes a load current and generates waste heat during operation, and the electric consumer operates to heat the traction battery. The device furthermore comprises a drive connection for connecting an electric drive. The electric consumer comprises a braking resistor for consuming regenerative electrical power from the electric drive.

A device for heating a traction battery in a vehicle is provided. The traction battery of a vehicle is preferably a DC voltage source, a battery, or a high voltage battery. The traction battery is used to supply electrical energy to an electric machine of an electric powertrain, wherein a DC voltage of the traction battery is preferably converted into a multi-phase AC voltage for supplying the electric machine by means of an inverter, preferably by means of a drive inverter. The device comprises an electric consumer that generates waste heat during operation. When operating an electric consumer, an electrical voltage is applied to the consumer, and a load current flows through the consumer. The waste heat generated during operation is used to heat the traction battery. The device for heating the traction battery comprises a connection for connecting an electric drive. Consequently, the device may be electrically coupled to an electric drive. The electric consumer comprises a braking resistor and is designed to consume regenerative electrical power from the electrical drive as described above, preferably in the event of a fault. During operation of the electric consumer, waste heat is generated, and is then used to heat the traction battery. Preferably, the device is adapted to read a temperature that characterizes the temperature of the traction battery and operate the electric consumer in response to the temperature. Preferably, the device operates the electric consumer when the temperature drops below a predetermined temperature value.

Advantageously, a device is provided that heats a traction battery in a vehicle by means of a braking resistor, wherein the braking resistor is actually present in the vehicle for a different purpose.

In another embodiment of the invention, the device comprises a cooling circuit connection for connecting the device to a cooling circuit that is connected to the traction battery.

A device for heating a traction battery that comprises a cooling circuit port is provided. A cooling circuit connection allows the device to be connected or incorporated into a cooling circuit, preferably an electric powertrain or a vehicle. Cooling circuits are preferably provided when a large amount of waste heat is generated when electrical components, such as electric machines, inverters and batteries, are loaded. The resulting waste heat is removed from a first electrical or mechanical component or heat source to a further component, and finally to a heat exchanger, by means of a cooling circuit which preferably contains a cooling fluid. The cooling fluid is cooled by means of the heat exchanger and conducted past the heat sources again to cool the respective components. By providing a cooling circuit connection, it is possible for the waste heat generated on the device or consumer to be dissipated via the cooling fluid. The cooling circuit is preferably also connected to the traction battery in the direction of flow downstream of the device, preferably before the cooling fluid is cooled by a heat exchanger that is also connected. Therefore, it is advantageously possible to heat the traction battery by means of the waste heat from the device, wherein the waste heat is conducted from the device to the traction battery by means of the cooling fluid.

In another embodiment of the invention, the device comprises a battery connection for making an electrical connection to a DC voltage connection of the traction battery to be heated.

A device for heating a traction battery that comprises a battery connection is provided. The battery connection allows the device to be directly electrically connected to the traction battery. When the consumer operates, current flows through the consumer. As a result, this current also flows through the battery via the battery connection. If current flows through the battery, waste heat is also formed within the battery. This advantageously provides another option for heating the traction battery by means of the device.

In another embodiment of the invention, the device comprises a brake inverter, which is connected between the drive connection and the consumer.

A device that comprises a brake inverter is provided. The brake inverter comprises an inverter. Inverters for converting DC voltage into multi-phase AC voltage preferably comprise half-bridges corresponding to the number of phases of the AC voltage to be produced. The half-bridges comprise a series connection of two controllable switching elements that are connected between the potentials of the DC voltage. A center tap between the switching elements of each half-bridge is respectively connected to a phase output of the inverter. Preferably, one consumer is respectively connected to the respective phase outputs. Consequently, the controllable brake inverter is connected between the drive connection and the at least one consumer. Advantageously, an option is provided to electrically connect the at least one consumer to the drive connection in a controllable manner, that is, such that it can be switched on and off. The invention furthermore relates to an electric powertrain for a vehicle, wherein the powertrain comprises a traction battery, a drive inverter, and a described device.

A powertrain of a vehicle is used to convert electrical energy from a power source, the traction battery, into mechanical energy used to propel the vehicle. In an electric powertrain, for example, the electrical energy from a power source is converted into an alternating voltage by means of an inverter, a drive inverter, with which an electric machine is operated. Preferably, the drive inverter is operated to heat the traction battery. During operation of the drive inverter, an electrical current flows through the drive inverter. This electrical current flows from the traction battery through the drive inverter and the coils of the electric machine. Advantageously, therefore, a powertrain is provided, the operation of which heats the traction battery. Heating in the powertrain takes place both by means of the waste heat from the device and the consumer or the current flow caused by the traction battery, and by means of the waste heat from the drive inverter and the windings of the electric machine or the current flow through the traction battery caused thereby.

The invention furthermore relates to a vehicle comprising a powertrain as described. Advantageously, a vehicle whose traction battery is efficiently heated by means of the device and/or the powertrain is provided.

The invention furthermore relates to a method of heating a traction battery. The method is performed with a device as described. This method includes the step of: operating the consumer to heat the traction battery.

A method is provided in which an electric consumer is operated for heating the traction battery. Preferably, the method comprises the following further steps: inputting a temperature characterizing the temperature of the traction battery to be heated and operating the electric consumer depending on the temperature, preferably operating the electric consumer when the temperature is below a predetermined temperature value. The electric consumer is comprised by a device. The device comprises a drive connection for connecting an electric drive. The electric consumer is a braking resistor that is set up to consume regenerative electrical power from a connected electrical drive. Advantageously, a method for efficient heating of a traction battery is provided.

In another embodiment of the invention, the operation of the electric consumer includes energizing the braking resistor, and the waste heat of the braking resistor is supplied to the traction battery via a cooling circuit.

Advantageously, a further method for efficient heating of a traction battery is provided.

In another embodiment of the invention, the operation of the electric consumer includes energizing the braking resistor, wherein the load current is withdrawn from the traction battery.

Advantageously, a further method for efficient heating of a traction battery is provided.

In another embodiment of the invention, the method is carried out with a powertrain as described. This method includes the step of: operating the drive inverter to heat the traction battery.

Advantageously, a further method for efficient heating of a traction battery is provided.

The invention furthermore relates to a computer program comprising instructions which cause the described device to perform the method steps described.

The invention furthermore relates to a computer-readable medium comprising instructions which, when executed by a described device, performs the described method.

It is understood that the features, characteristics, and advantages of the device apply or are applicable, mutatis mutandis, to the process or the powertrain and the vehicle, and vice versa.

Further features and advantages of embodiments of the invention follow from the subsequent description with reference to the accompanying drawings.

### BRIEF DESCRIPTION OF THE DRAWINGS

The invention will be explained in further detail hereinafter with reference to the drawings:

FIG. 1 schematic diagram of a device for heating a traction battery

FIG. 2 schematic view of a vehicle with a powertrain with a device

FIG. 3 schematic depiction of a method for heating a traction battery.

### DETAILED DESCRIPTION

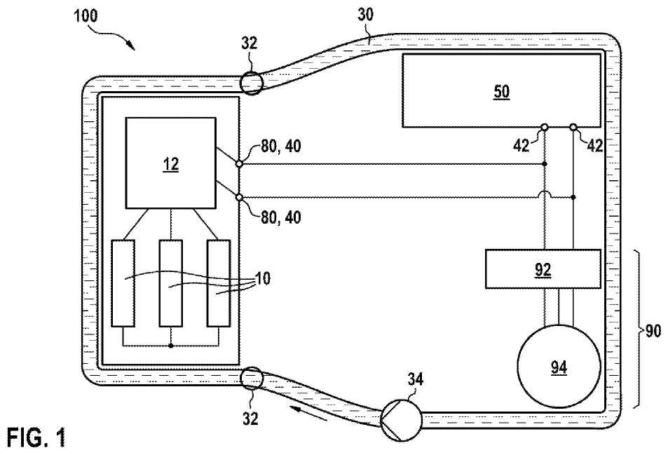

FIG. 1 shows a device 100 for heating a traction battery 50. The device 100 comprises at least one electric consumer 10. The device 100 comprises a drive connection 80 for connecting an electric drive 90. Preferably, the electric drive 90 comprises an inverter, the drive inverter 92, and/or an electric machine 94. The electric consumer 10 includes a braking resistor and is adapted to consume regenerative electrical power from the connectable electrical drive 90. The consumer 10 is preferably configured as an ohmic, capacitive and/or inductive consumer. The consumer 10 is preferably integrally formed or formed from a plurality of similar or different individual consumers 10. During operation, the electric consumer 10 draws a load current and generates waste heat. Consequently, the electric consumer 10 is operated to heat the traction battery. Preferably, the device 100 includes a cooling circuit connection 32 for connecting the device to a cooling circuit 30 that is connected to the traction battery 50 for this purpose. The cooling circuit 30 is preferably connected to the device 100. In the direction of flow (illustrated by an arrow) along the cooling circuit 30, the traction battery 50 is arranged downstream of the device 100 with the consumer 10 so that waste heat of the device 100 is transported to the traction battery 50 by means of the cooling fluid, wherein the traction battery is preferably also connected to the cooling circuit 30. Furthermore, the cooling circuit 30 comprises a heat exchanger and a pump 34 that is arranged downstream of the traction battery 50 in the cooling circuit 30 along the direction of flow, wherein the heat exchanger and pump cool and transport the cooling fluid before it flows past the device 100 again. Preferably, the device 100 comprises a battery connection 40 for making an electrical connection to a DC connection 42 of the traction battery 50 which is to be heated. The battery connection 40 may preferably be arranged integrally with the drive connection 80, i.e., as a common, preferably two-pole, connection, since the DC voltage potentials of the device 100, the traction battery 50, and the electric drive 90 are preferably connected to each other at this point. Preferably, the device comprises a further inverter, the brake inverter 12. The brake inverter 12 is connected between the drive connection 80 and the consumer 10. As an example, the brake inverter 12 is designed as a three-phase inverter, wherein a consumer 10 is preferably connected to each phase. As an example, the three consumers 10 are connected together to form a star or a triangle at each connection. Preferably, the brake inverter 12 comprises switching elements that are arranged as half bridges per phase. The switching elements are selectively opened and closed when an inverter is operated. By closing individual switching elements, the connections of a consumer can be connected to one of the DC voltage potentials of the device 100 or the inverter, respectively. As a result, current flow through at least one of the consumers 10 results via the battery connection 40 and the drive connection 80. This operating state in which a current flows through a consumer 10 and/or an inverter 12, 92 is referred to as operation or operating the consumer 10 and/or the inverter 12, 92.

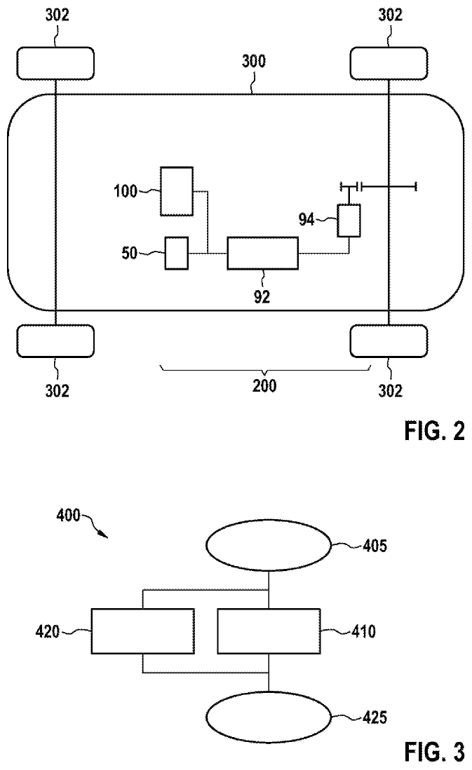

FIG. 2 shows a schematic view of a vehicle 300 with four wheels 302 and a powertrain 200. The vehicle 300 is shown with four wheels 302 herein only by way of example, although the invention is equally applicable to any vehicle comprising any number of wheels on land, water, and in the air. The exemplary powertrain 200 comprises at least the traction battery 50, the drive inverter 92, and the device 100. Preferably, the powertrain comprises an electric machine 94. The power of the traction battery 50 is converted to an alternating voltage, such as three-phase voltage, for operating the electric machine 94 as a drive unit for a vehicle 300, using the drive inverter 92. Both individual and all of the illustrated electrical components may be connected to a cooling circuit (not shown), such that waste heat can be conveyed from one component to the next, and all components can preferably be cooled by means of the cooling circuit.

FIG. 3 shows a schematic flowchart for a method 400 of heating a traction battery 50. The method 400 starts with step 405. In step 410, the electric consumer 10 of the device 100 is operated to heat the traction battery 50. Preferably, the operation 410 of the electric consumer 10 includes energizing the braking resistor, and the resulting waste heat from the braking resistor is supplied to the traction battery 50 via a cooling circuit 30. Preferably, the operation 410 of the electric consumer 10 comprises energizing the braking resistor, and the load current through the consumer 10 is drawn from the traction battery 50. Preferably, the load current through the consumer 10 is drawn from an external power source connectable to the battery connection 40 and/or the drive connection 80 outside of the vehicle. Preferably, the connectable external power source is a public power grid or a charger connected to the public power grid. Preferably, the method comprises step 420, wherein the drive inverter 92 is operated to heat the traction battery 50. The method ends at step 425.

1. A device (100) for heating a traction battery (50) in a vehicle (300),
wherein the device (100) comprises an electric consumer (10), wherein the electric consumer (10) draws load current and generates waste heat during operation,
and wherein the electric consumer (10) operates to heat the traction battery (50)
wherein
the device (100) comprises a drive connection (80) for connecting an electric drive (90), and the electric consumer (10) comprises a braking resistor for consuming regenerative electrical power of the electrical drive (90).

2. The device according to claim 1,
wherein the device (100) comprises a cooling circuit connection (32) for connecting the device to a cooling circuit (30) that is connected to the traction battery (50).

3. The device according to claim 1,
wherein the device (100) comprises a battery connection (40) for making an electrical connection to a DC voltage connection (42) of the traction battery (50) to be heated.

4. The device according to claim 1,
wherein the device comprises a brake inverter (12) connected between the drive connection (80) and the consumer (10).

5. An electrical powertrain (200) for a vehicle,
wherein the powertrain comprises a traction battery (50), a drive inverter (92), and a device (100) according to claim 1.

6. The electrical powertrain (200) according to claim 5, wherein
the drive inverter (92) is operated to heat the traction battery (50).

7. A vehicle (300) comprising a powertrain (200) according to claim 5.

8. A method (400) of heating a traction battery (50) with a device (100) that includes an electric consumer (10), wherein the electric consumer (10) draws load current and generates waste heat during operation, and operates to heat the traction battery (50), and the device (100) also includes a drive connection (80) for connecting an electric drive (90), and the electric consumer (10) comprises a braking resistor for consuming regenerative electrical power of the electrical drive (90), the method comprising:
operating (410) the electric consumer (10) to heat the traction battery (50).

9. The method (400) according to claim 8,
wherein the operation (410) of the electric consumer (10) comprises energizing the braking resistor, and the waste heat of the braking resistor is supplied to the traction battery (50) via a cooling circuit (30).

10. The method (400) according to claim 9,
wherein the operation (410) of the electric consumer (10) comprises energizing the braking resistor and removing the load current from the traction battery (50).

11. The method (400) of heating a traction battery (50), comprising a powertrain (200) according to claim 5, further comprising:
operating (420) the drive inverter (92) to heat the traction battery (50).

12. (canceled)

13. A non-transitory, computer-readable medium comprising instructions that, when executed by a computer cause the computer control heating a traction battery (50) with a device (100) that includes an electric consumer (10), wherein the electric consumer (10) draws load current and generates waste heat during operation, and operates to heat the traction battery (50), and the device (100) also includes a drive connection (80) for connecting an electric drive (90), and the electric consumer (10) comprises a braking resistor for consuming regenerative electrical power of the electrical drive (90), by:
operating (410) the electric consumer (10) to heat the traction battery (50).
